(19) United States
(12) Patent Application Publication
(10) Pub. No.: US 2007/0132909 A1
(43) Pub. Date: Jun. 14, 2007

(54) Liquid crystal display device

(75) Inventor: Eiji Oohira, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 11/599,423

(22) Filed: Nov. 15, 2006

(30) Foreign Application Priority Data
Dec. 9, 2005 (JP) 2005-355905

(51) Int. Cl. G02F 1/1333

(52) U.S. Cl. 349/58

(57) ABSTRACT

The present invention provides a liquid crystal display device which can realize the reduction of thickness of substrates and the miniaturization of a profile size thereof. In a liquid crystal display device which includes a liquid crystal display panel, a backlight which is arranged on a side opposite to a viewer of the liquid crystal display panel, and a frame, the backlight has a frame-like mold, the liquid crystal display panel has a surface thereof on a side remote from the viewer fixed to a surface thereof on a viewer's side of the frame-like mold, a side surface of the liquid crystal display panel is retracted to the inside of the frame-like mold than a side surface of the frame-like mold, and the liquid crystal display panel and the frame-like mold are housed in the inside of the frame without interposing a resin between the side surface of the liquid crystal display panel and the frame.

The present application claims priority from Japanese application JP2005-355905 filed on Dec. 9, 2005, the content of which is hereby incorporated by reference into this application.

### BACKGROUND OF THE INVENTION

The present invention relates to a liquid crystal display device, and more particularly to a technique which is effectively applicable to a backlight which houses a light guide plate, a group of optical sheets and the like therein.

A liquid crystal display module of a TFT (Thin Film Transistor) type which possesses a miniaturized liquid crystal display panel having the number of sub pixels amounting to approximately 240×320×3 in a color display has been popularly used as a display part of a portable equipment such as a mobile phone.

In general, the liquid crystal display module includes a liquid crystal display panel and a backlight which radiates light to the liquid crystal display panel, wherein with respect to the liquid crystal display module which is used as a display part of aportable equipment such as a mobile phone, the backlight is constituted of a resin mold frame (hereinafter, referred to as a mold), a group of optical sheets and a light guide plate which are arranged in the inside of the mold, and a reflection sheet which is arranged on a lower side of the light guide plate.

Recently, the liquid crystal display module for mobile phones adopts the structure which eliminates a bottom surface of the mold as a main stream to satisfy a demand for the reduction of thickness of the liquid crystal display module.

FIG. 5 is a developed perspective view showing the schematic structure of one example of a liquid crystal display module for a conventional mobile phone, and FIG. 6 is a cross-sectional view of an essential part taken along a line A-A′ in FIG. 5.

In FIG. 5, symbol B/L indicates a backlight. The backlight (B/L) includes a mold 20, a group of optical sheets 5 which is arranged in the inside of the mold 20, a light guide plate 6, a white light emitting diode (a light source) 8 which is arranged on one side surface (an incident surface side) of the light guide plate 6, and a reflection sheet 7 which is fixed to a lower side of the mold 20 using a pressure-sensitive adhesive double-coated tape 15. Here, the group of optical sheets 5 is constituted of an upper diffusion sheet 5a, two lens sheets 5b, 5c and a lower diffusion sheet 5d.

Further, the liquid crystal display panel 10 includes a liquid crystal cell 2, an upper polarizer 1 which is adhered to an upper surface (a display screen) of the liquid crystal cell 2, and a lower polarizer 3 which is adhered to a lower side (a backlight-surface-side) of the liquid crystal cell 2.

The liquid crystal cell 2 includes a pair of transparent substrates (2a, 2b) and liquid crystal which is sandwiched between the pair of substrates. Further, a semiconductor chip (DRV) which constitutes a driver or the like is mounted on the glass substrate 2b. Although a flexible printed wiring board which supplies control signals or the like to the semiconductor chip (DRV) is also mounted on the glass substrate 2b, the illustration of the flexible printed wiring board is omitted from FIG. 5.

As shown in FIG. 6, the mold 20 has a side wall 20a, and the liquid crystal display panel 10 is fixed to a stepped portion which is formed on an inner side of the side wall 20a of the mold 20 using a pressure-sensitive adhesive double-coated tape 9. That is, the example shown in FIG. 5 adopts the structure in which the glass substrate 2b of the liquid crystal display panel 10 is fixed to the stepped portion of the mold 20 using the pressure-sensitive adhesive double-coated tape 9 and the lower polarizer 3 is made to fall into the inside the mold 20.

FIG. 7A to FIG. 7C are cross-sectional views of essential parts of another examples of a liquid crystal display module for a conventional mobile phone. Here, in FIG. 7A to FIG. 7C, FIG. 7A shows a half-completed product, FIG. 7B shows a shipping state, and FIG. 7C shows a final set assembling state.

In FIG. 7A to 7C, numeral 21 indicates a first resin frame, numeral 22 indicates a second resin frame, and numeral 30 indicates a metal frame. Further, FIG. 7A to FIG. 7C are views showing the cross-sectional structures of parts corresponding to the part shown in FIG. 6 which is the cross-sectional view of an essential part.

The liquid crystal display module shown in FIG. 7A to 7C differs from the liquid crystal display module shown in FIG. 5 with respect to points that the first resin frame 21 does not have the side wall 20a so that an end surface of the liquid crystal display panel (an end surface of substrates (2a, 2b)) and a side surface of the fist resin frame 21 are aligned with each other, and the second resin frame 22 is provided outside the first resin frame 21.

That is, the liquid crystal display module shown in FIG. 7 is configured such that the mold 20 shown in FIG. 5 is divided into the first resin frame 21 and the second resin frame 22.

### SUMMARY OF THE INVENTION

Recently, with respect to the liquid crystal display module for the mobile phone, there has been a strong demand for the reduction of thickness of the substrates (2a, 2b) and the miniaturization of a profile size of the module.

In the above-mentioned liquid crystal display module shown in FIG. 5, when the thickness of the substrates (2a, 2b) is reduced, it is necessary to lower a height of the side wall 20a of the mold 20. However, when the height of the side wall 20a of the mold 20 is lowered, there arises a drawback that abutting assembling which is performed for enhancing the assembling accuracy of the liquid crystal display panel 10 deteriorates the operability thereof.

Further, in performing the abutting assembling of the liquid crystal display panel 10 having the substrates (2a, 2b) which exhibit the small thickness, the end surface of the liquid crystal display panel 10 is liable to be easily adhered to an inner wall of the side wall 20a of the mold 20. Accordingly, in a state that the end surface of the liquid crystal display panel 10 is adhered to the inner wall of the side wall 20a of the mold 20, when the deformation or an indirect stress which is generated in the side wall 20a of the mold 20 due to an external force is directly transmitted to the substrates (2a, 2b), there exists a possibility that the substrate is cracked.

Further, the side wall 20a shown in FIG. 6 has a width of approximately 0.6 mm thus increasing the profile size of the liquid crystal display module. Further, in any one of the liquid crystal display modules shown in FIG. 5 and FIG. 7A to FIG. 7C, in a state that the liquid crystal display module is assembled into a final set, in general, for example, as in the case of the side wall 20a of the resin mold 20, the second resin frame 22 and the like, a resin or the like is present between the liquid crystal display module and a metal casing for imparting cushion property to the liquid crystal display module.

Accordingly, there exists a drawback that the resin or the like which serves to impart the cushion property to the liquid crystal display module impedes the miniaturization of the liquid crystal display module.

The present invention has been made to overcome the above-mentioned drawbacks of the related art and it is an advantage of the present invention to provide a technique which can achieve the reduction of thickness of substrates and the miniaturization of a profile size of a liquid crystal display device.

The above-mentioned and other advantages of the present invention and novel features of the present invention will become apparent from the description of this specification and attached drawings.

To briefly explain the summary of the typical inventions among inventions disclosed in this specification, they are as follows.

(1) In a liquid crystal display device which includes a liquid crystal display panel, a backlight which is arranged on a side opposite to a viewer of the liquid crystal display panel, and a frame, the backlight has a frame-like mold, the liquid crystal display panel has a surface thereof on a side remote from the viewer fixed to a surface thereof on a viewer's side of the frame-like mold, a side surface of the liquid crystal display panel is retracted to the inside of the frame-like mold than a side surface of the frame-like mold, and the liquid crystal display panel and the frame-like mold are housed in the inside of the frame without interposing a resin between the side surface of the liquid crystal display panel and the frame.

(2) In the liquid crystal display device having the above-mentioned constitution (1), a distance between the side surface of the frame-like mold and the side surface of the liquid crystal display panel is set to 0.3 mm or more and 1 mm or less.

(3) In the above-mentioned liquid crystal display device having the constitution (1) or (2), the liquid crystal display panel has a lower polarizer on the surface thereof on the side remote from the viewer, and the liquid crystal display panel is fixed to the surface of the frame-like mold on the viewer side in a region from an outside of the lower polarizer to an end portion of the liquid crystal display panel.

(4) In the above-mentioned liquid crystal display device having anyone of the constitutions (1) to (3), the liquid crystal display panel is fixed to the surface of the frame-like mold on the viewer's side using a pressure-sensitive adhesive double-coated tape.

(5) In the above-mentioned liquid crystal display device having any one of the constitutions (1) to (4), the backlight includes at least one optical sheet which is arranged in the inside of the frame-like mold and a light guide plate which is arranged in the inside of the frame-like mold, at least one side of the frame-like mold has a first portion and a second portion which change a distance with an opposing side in a step-like manner, the second portion exhibits the narrower distance with the opposing side than the first portion, at least one optical sheet is supported on a first stepped portion which is formed by the first portion and the second portion, and the light guide plate is arranged on an inner side of the second portion.

(6) In the above-mentioned liquid crystal display device having the constitution (5), the liquid crystal display panel has at least one optical sheet which is arranged on the inner side of the second portion.

(7) In the above-mentioned liquid crystal display device having the constitution (5) or (6), the first portion and the second portion have a frame width of the frame-like mold changed in a step like manner, and the second portion has a wider frame width of the frame-like mold than the first portion.

(8) In the above-mentioned liquid crystal display device having any one of the constitutions (5) to (7), the side of the frame-lime mold on which the first portion and the second portion are formed is a long side of the frame-like mold.

(9) In the above-mentioned liquid crystal display device having any one of the constitutions (1) to (8), the frame is made of metal, and the mold is made of a resin.

To briefly explain advantages obtained by the typical inventions among the inventions disclosed in this specification, they are as follows.

According to the liquid crystal display device of the present invention, the reduction of thickness of the substrates and the miniaturization of a profile size can be realized.

### BRIEF DESCRIPTION OF THE DRAWINGS

FIG. 1 is a developed perspective view showing the schematic structure of one example of a liquid crystal display module for a mobile phone of an embodiment of the present invention;

FIG. 2 is a cross-sectional view of an essential part taken along a line A-A′ in FIG. 1;

FIG. 3 is a cross-sectional view of an essential part for explaining a modification of a mold shown in FIG. 1;

FIG. 4 is a cross-sectional view of an essential part for explaining another modification of the mold shown in FIG. 1;

FIG. 5 is a developed perspective view showing the schematic structure of one example of a liquid crystal display module for a conventional mobile phone;

FIG. 6 is a cross-sectional view of an essential part taken along a line A-A′ in FIG. 5;

FIG. 7A to FIG. 7C are cross-sectional views of an essential part of another examples of the liquid crystal display module of the conventional mobile phone;

FIG. 8A and FIG. 8B are views for explaining drawbacks of the liquid crystal display module shown in FIG. 5;

FIG. 9A and FIG. 9B are views for explaining drawbacks of the liquid crystal display module shown in FIG. 5; and

FIG. 10A and FIG. 10B are views for explaining drawbacks of the liquid crystal display module shown in FIG. 5.

### DESCRIPTION OF THE PREFERRED EMBODIMENTS

Hereinafter, embodiments of the present invention are explained in detail in conjunction with drawings.

Here, in all drawings for explaining the embodiments, parts having identical functions are indicated by same symbols and their repeated explanation is omitted.

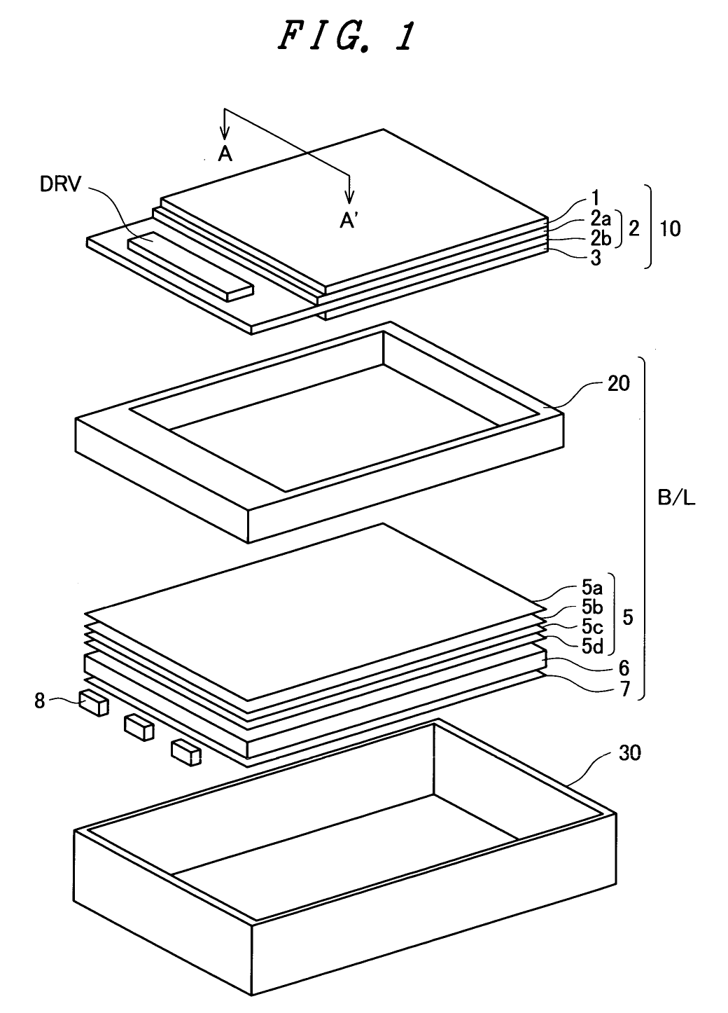

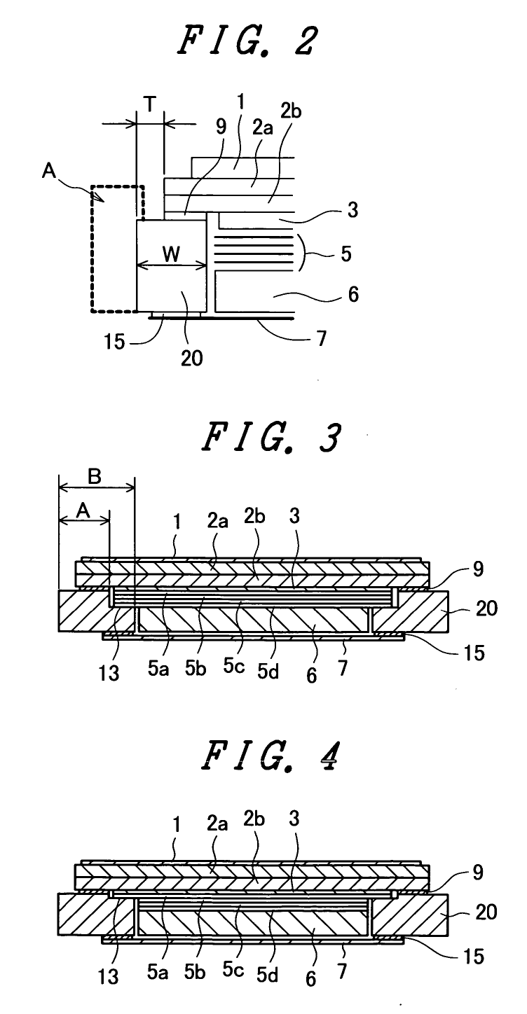

FIG. 1 is a developed perspective view showing the schematic structure of one example of a liquid crystal display module for a mobile phone of an embodiment of the present invention. Further, FIG. 2 is a cross-sectional view of an essential part taken along a line A-A′ in FIG. 1. Here, in FIG. 2, the illustration of a metal frame 30 is omitted.

In FIG. 1, symbol B/L indicates a backlight. The backlight (B/L) includes a resin-made mold 20, a group of optical sheet 5 which is arranged in the inside of the mold 20, a light guide plate 6, white light emitting diodes (a light source) 8 which are arranged on one side surface (incident surface) of the light guide plate 6, and a reflection sheet 7 which is fixed to a lower side of the mold 20 using a pressure-sensitive adhesive double-coated tape 15. Here, the group of optical sheets 5 is, for example, constituted of upper diffusion sheet 5a, two lens sheets (5b, 5c) and a lower diffusion sheet 5d. The number of the optical sheets which constitutes the group of optical sheets 5 and kinds of the optical sheets are not limited to the above-mentioned upper diffusion sheet 5a, two lens sheets (5b, 5c) and lower diffusion sheet 5d.

Further, a liquid crystal display panel 10 includes a liquid crystal cell 2, an upper polarizer 1 which is adhered to an upper surface (display screen) of the liquid crystal cell 2, and a lower polarizer 3 which is adhered to a lower surface (backlight-surface side) of the liquid crystal cell 2.

The liquid crystal cell 2 is configured, for example, such that the transparent substrate 2b which is formed of a glass substrate or the like and mounts pixel electrodes, thin film transistors and the like thereon (also referred to as TFT substrates) and the transparent substrates 2a which is formed of a glass substrate or the like and forms color filters and the like thereon are overlapped to each other with a predetermined gap therebetween, both substrates are adhered to each other using a sealing material which is formed in a frame-like shape in the vicinity of a peripheral portion between both substrates, and liquid crystal is filled and sealed in the inside of the sealing material between both substrates through a liquid crystal filling opening formed in a portion of the sealing material.

On the glass substrate 2b, a semiconductor chip (DRV) which constitutes a driver or the like is mounted. Here, although a flexible printed wiring board which supplies control signals to a semiconductor chip (DRV) is also mounted on the glass substrate 2b, in FIG. 1, the illustration of the flexible printed wiring board is omitted.

As shown in FIG. 2, the liquid crystal display panel 10 is fixed to an upper surface side of the mold 1 using a pressure-sensitive adhesive double-coated tape 9. That is, this embodiment adopts the structure in which the glass substrate 2b of the liquid crystal display panel 10 is fixed to an upper-surface side (viewer-side surface) of the mold 20 using a pressure-sensitive adhesive double-coated tape 9, and the lower side polarizer 3 falls in the inside of the mold 20.

In this embodiment, the backlight (B/L) and the liquid crystal display panel 10 which is arranged above the backlight (B/L) are incorporated into a metal frame 30.

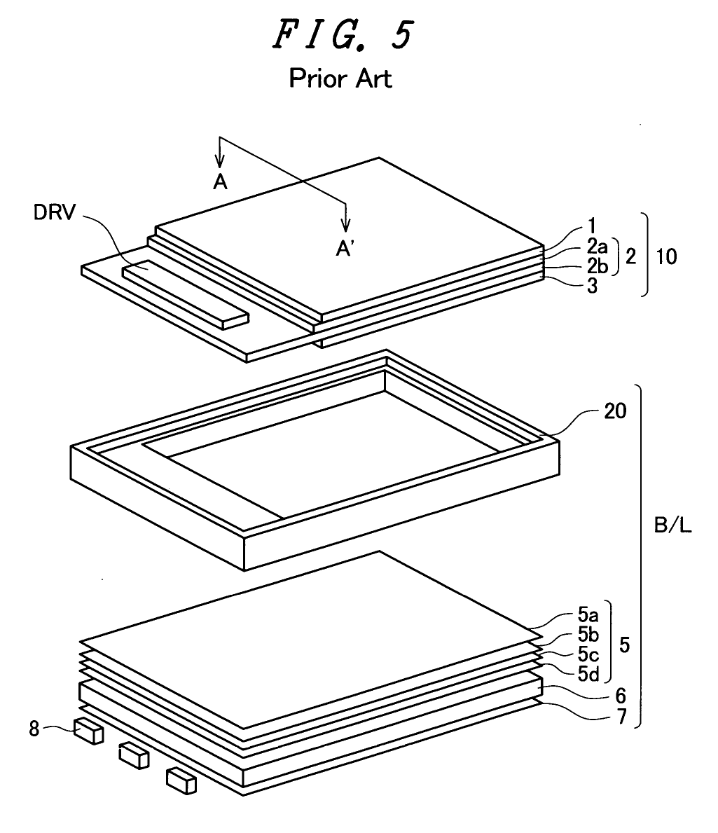

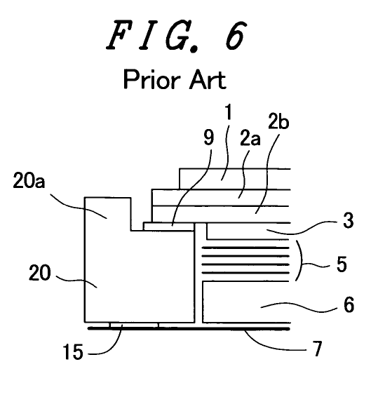

As shown in FIG. 2, in this embodiment, the mold 20 does not have a side wall 20a and, at the same time, a width (W in FIG. 2) of the mold 20 is set narrower than a width of the mold of the liquid crystal display module shown in FIG. 5.

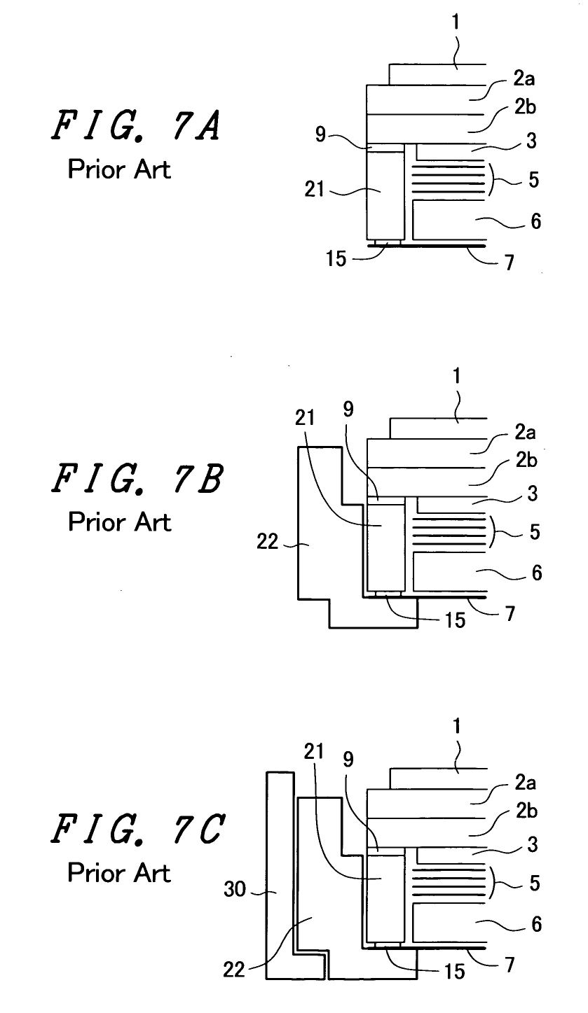

Further, the mold of this embodiment 20 differs from the first resin frame 21 of the liquid crystal display module shown in FIG. 7A to FIG. 7C with respect to a point that a predetermined distance (T in FIG. 2) is provided between an end surface (end surface of the substrate (2a, 2b) (side surface)) of the liquid crystal display panel and the side surface of the mold 20.

Hereinafter, drawbacks which the liquid crystal display module shown in FIG. 5 possesses are explained.

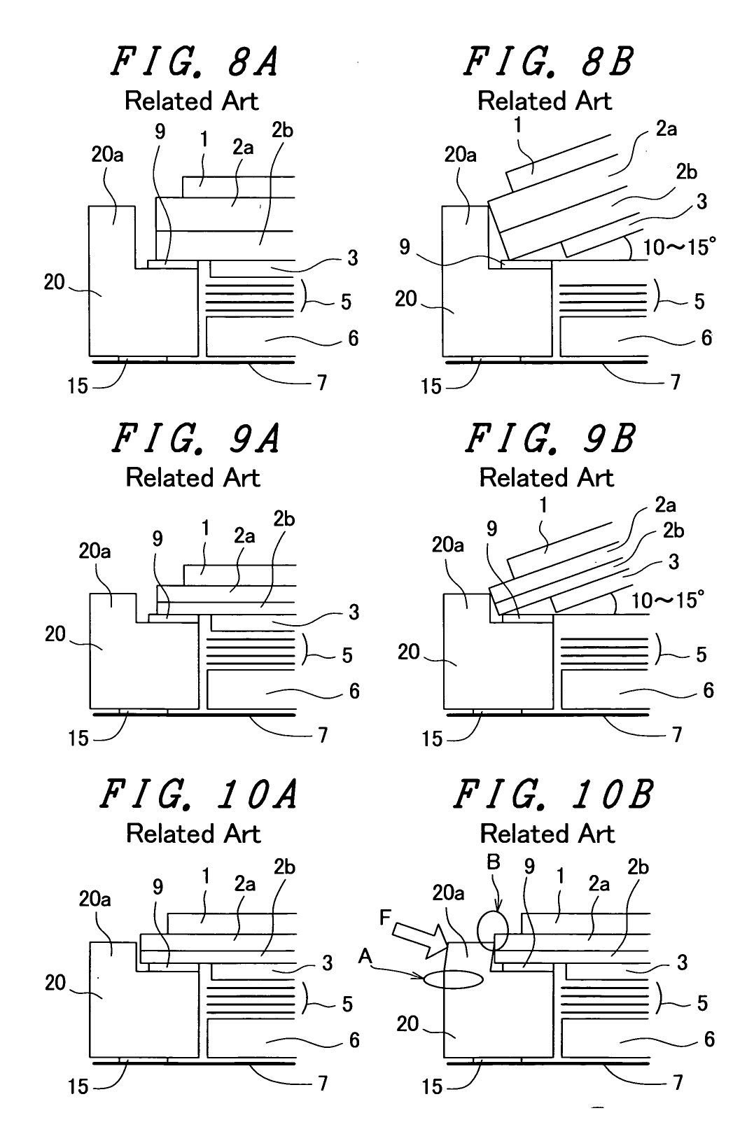

As shown in FIG. 8A, when the thickness of the substrate (2a, 2b) is large, (for example, the total thickness of two substrates (2a, 2b) is approximately 1 mm), as shown in FIG. 8B, a height of the side wall 20a of the mold 20 is sufficiently high and hence, it is possible to easily make the substrates (2a, 2b) abut against a side wall 20a.

However, since the side wall 20a of the mold 20 is designed to be slightly lower than the substrate 2a of the liquid crystal display panel 10, as shown in FIG. 9A, when the thicknesses of the substrates (2a, 2b) become small, the height of the side wall 20a of the mold 20 is lowered.

Accordingly, as shown in FIG. 9B, in performing the abutting assembling to enhance the assembling accuracy of the liquid crystal display panel 10, the operability of the assembling is deteriorated. For example, when the total thickness of two substrates (2a, 2b) becomes 0.6 mm or less, the operability is remarkably deteriorated.

Further, as shown in FIG. 10A, when the abutting assembling is performed with the liquid crystal display panel 10 having the substrates (2a, 2b) with small thicknesses, an end surface of the liquid crystal display panel 10 is liable to be easily brought into contact with an inner surface of the side wall 20a of the mold 20.

Further, as shown in FIG. 10B, in a state that the end surface of the liquid crystal display panel 10 is brought into close contact with the inner wall of the side wall 20a of the mold 20, the side wall 20a of the mold 20 is deformed by an external force F as indicated by A in FIG. 10B and an indirect stress is, as indicated by B in FIG. 10B, directly transmitted to the substrates (2a, 2b) thus giving rise to a possibility that the substrate is cracked.

However, in this embodiment, the mold 20 does not have the side wall 20a and forms a planner shape and hence, it is possible to prevent the generation of the phenomenon that the side wall 20a of the mold 20 is deformed and the indirect stress is directly transmitted to the substrates (2a, 2b) of the liquid crystal display panel 10 thus cracking the substrate.

Further, in this embodiment, the predetermined distance (T in FIG. 2) is provided between the end surface (the end surface of the substrate (2a, 2b)) of the liquid crystal display panel and the side surface of the mold 20. Accordingly, even when vibrations or the like are applied to the liquid crystal display module, the distance prevents the substrates (2a, 2b) of the liquid crystal display panel 10 from being in contact with the metal frame 30 and hence, it is possible to prevent a phenomenon that an indirect stress is transmitted to the substrates (2a, 2b) of the liquid crystal display panel 10 thus cracking the substrate.

Here, the predetermined distance (T in FIG. 2) may be preferably set to 0.3 mm≦T≦1 mm.

This embodiment adopts the structure in which a resin is not interposed between the side surface of the liquid crystal display panel 10 and the metal frame 30. That is, this embodiment adopts the structure which does not interpose the side wall 20a and the second resin frame 22.

Accordingly, in this embodiment, a width of the mold 20 (W in FIG. 2) can be narrowed by an amount corresponding to a portion indicated by A in FIG. 2 (a portion of the side wall having a width of approximately 0.6 mm). Further, in a state that the liquid crystal display module is assembled into the inside of the metal frame 30, the second resin frame 22 shown in FIG. 7 is not present and hence, it is possible to achieve the further miniaturization of the profile size of the liquid crystal display module.

FIG. 3 is a cross-sectional view of an essential part for explaining a modification of the mold 20 shown in FIG. 1. Here, in FIG. 3 and FIG. 4 described later, the illustration of the metal frame 30 is omitted.

The mold 20 of this embodiment adopts the structure in which a bottom surface is eliminated and an opening portion is formed at a center portion thereof, that is, a frame-like body (or a cylindrical body) having an approximately quadrangular cross section. In the example shown in FIG. 3, a size of a light guide plate 6 is set to a size which is obtained by adding a region of a necessary minimum to a size of a pixel region of a liquid crystal display panel 10 by taking irregularities such as matching displacement into consideration or a size which ensures a minimum region necessary for injection molding.

Accordingly, the modification shown in FIG. 3 adopts the structure in which a frame width of the mold 20 surrounding the light guide plate 6 is increased to make the mold 20 approach the light guide plate side. That is, in the modification shown in FIG. 3, two sides of the mold 20 (preferably long sides of the mold 20) (sides orthogonal to an incident surface of the light guide plate 6) respectively have a first portion and a second portion which change a distance between these portions and opposing sides in a step-like manner.

Here, the second portion (the portion indicated by B in FIG. 3) sets the distance between the second portion and the opposing side smaller than the distance between the first portion (the portion indicated by A in FIG. 3) and the opposing side.

Further, a peripheral portion of the substrate 2b of the liquid crystal display panel 10 (a region ranging from the outside of a lower polarizer 3 to an end surface of the liquid crystal display panel 10) is supported on and is fixed to the first portion A of the mold 20 using a pressure-sensitive adhesive double-coated tape (adhesive member) 9.

Further, a fist stepped portion 13 is formed of the first portion A and the second portion B and a group of optical sheets 5 is supported on the stepped portion 13. Further, a light guide plate 6 is arranged inside the second portion B. Below the light guide plate 6, a reflection sheet 7 is arranged to cover the opening portion of the mold 20. The reflection sheet 7 is supported and is fixed to a back surface side of the mold 20 using a pressure-sensitive adhesive double-coated tape 15.

Since the light guide plate 6 is arranged on the second portion B, an area of the light guide plate 6 can be reduced. Accordingly, it is possible to increase the luminance per unit area.

Further, in the modification shown in FIG. 3, an end portion of the lower polarizer 3 is positioned within the stepped portion 13. That is, as viewed in a plan view, the end portion of the lower polarizer 3 is overlapped to the stepped portion 13.

Here, in the example shown in FIG. 3, as a method for making the inner wall of the mold 20 approach the light guide plate 6, either one of a method which partially increases the thickness of the mold 20 and a method which moves a position of the wall toward the inside while maintaining the same frame width may be selected.

From a viewpoint of enhancing durability, as shown in FIG. 3, it is desirable to increase the frame width of the frame-like mold 20 at the second portion B than the fist portion A.

Due to such a constitution, in the modification shown in FIG. 3, it is possible to enhance the luminance compared to the conventional structure while realizing the reduction of the thickness of the liquid crystal display module.

Here, in this embodiment, a group of optical sheets 5 which is supported on the stepped portion 13 may be constituted of at least one optical sheet.

FIG. 4 is a cross-sectional view of an essential part for explaining another modification of the mold 20 shown in FIG. 1.

For example, as shown in FIG. 4, out of the group of optical sheets 5, an upper diffusion sheet 5a may be supported on the stepped portion 13, and other optical sheets (two lens sheets (5b, 5c) and a lower diffusion sheet 5d) may be arranged inside the second portion B and above the light guide plate 6.

Here, as shown in FIG. 4, the upper diffusion sheet 5a among the group of the optical sheets 5 is supported on the stepped portion 13 for preventing dusts or the like from intruding into the inside of the second portion B.

Here, the constitution of the group of optical sheets 5 is not limited to the above-mentioned constitution and hence, it is sufficient that at least one optical sheet is arranged above the stepped portion 13 and the number of the optical sheets which are arranged inside the second portion B is not particularly limited.

Although the inventions which are made by inventors of the present inventions are specifically explained in conjunction with above-mentioned embodiments heretofore, it is needless to say that the present invention is not limited to the above-mentioned embodiment and various modifications are conceivable without departing from the gist of the present invention.

What is claimed is:

1. A liquid crystal display device comprising:
a liquid crystal display panel;
a backlight which is arranged on a side opposite to a viewer of the liquid crystal display panel; and
a frame, wherein
the backlight has a frame-like mold, wherein
the liquid crystal display panel has a surface thereof on a side remote from the viewer fixed to a surface thereof on a viewer's side of the frame-like mold,
a side surface of the liquid crystal display panel is retracted to the inside of the frame-like mold than a side surface of the frame-like mold, and
the liquid crystal display panel and the frame-like mold are housed in the inside of the frame without interposing a resin between the side surface of the liquid crystal display panel and the frame.

2. A liquid crystal display device according to claim 1, wherein a distance between the side surface of the frame-like mold and the side surface of the liquid crystal display panel is set to 0.3 mm or more and 1 mm or less.

3. A liquid crystal display device according to claim 1, wherein the liquid crystal display panel has a lower polarizer on the surface thereof on the side remote from the viewer, and
the liquid crystal display panel is fixed to the surface of the frame-like mold on the viewer side in a region from an outside of the lower polarizer to an end portion of the liquid crystal display panel.

4. A liquid crystal display device according to claim 1, wherein, the liquid crystal display panel is fixed to the surface of the frame-like mold on the viewer's side using a pressure-sensitive adhesive double-coated tape.

5. A liquid crystal display device according to claim 1, wherein the backlight includes at least one optical sheet which is arranged in the inside of the frame-like mold, and a light guide plate which is arranged in the inside of the frame-like mold,
at least one side of the frame-like mold has a first portion and a second portion which change a distance with an opposing side in a step-like manner,
the second portion exhibits the narrower distance with the opposing side than the first portion,
at least one optical sheet is supported on a first stepped portion which is formed by the first portion and the second portion, and
the light guide plate is arranged on an inner side of the second portion.

6. A liquid crystal display device according to claim 5, wherein the liquid crystal display panel has at least one optical sheet which is arranged on the inner side of the second portion.

7. A liquid crystal display device according to claim 5, wherein the first portion and the second portion have a frame width of the frame-like mold changed in a step like manner, and the second portion has a wider frame width of the frame-like mold than the first portion.

8. A liquid crystal display device according to claim 5, wherein the side of the frame-like mold on which the first portion and the second portion are formed is a long side of the frame-like mold.

9. A liquid crystal display device according to claim 1, wherein the frame is made of metal, and the mold is made of a resin.
